(19) United States
(12) Patent Application Publication
(10) Pub. No.: US 2026/0045659 A1
(43) Pub. Date: Feb. 12, 2026

(54) SECONDARY BATTERY AND METHOD FOR MANUFACTURING SAME

(71) Applicant: SAMSUNG SDI CO, LTD., Yongin-si (KR)

(72) Inventor: Taewoong JANG, Yongin-si (KR)

(21) Appl. No.: 19/004,782

(22) Filed: Dec. 30, 2024

(30) Foreign Application Priority Data
Aug. 12, 2024 (KR) 10-2024-0107514

(51) Int. Cl. H01M 50/564; H01M 10/04; H01M 50/103; H01M 50/15; H01M 50/166; H01M 50/55

(52) U.S. Cl. CPC H01M 50/564; H01M 10/049; H01M 50/103; H01M 50/15; H01M 50/166; H01M 50/55

(57) ABSTRACT

A secondary battery, including an electrode assembly including an electrode tab protruding to one side, a case accommodating the electrode assembly and having an open side and an electrode terminal, a case cover sealing the open side of the case, and an anisotropic conductive film on the electrode tab, the anisotropic conductive film electrically connecting and joining the electrode tab and the electrode terminal.

### CROSS-REFERENCE TO RELATED APPLICATION

The present application claims priority to and the benefit of Korean Application No. 10-2024-0107514, filed on Aug. 12, 2024, in the Korean Intellectual Property Office, the entire disclosure of which is incorporated by reference herein.

### BACKGROUND

### 1. Field

Embodiments relate to a secondary battery and a method for manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments are directed to a secondary battery, including an electrode assembly including an electrode tab protruding to one side; an electrode assembly including an electrode tab protruding to one side; a case accommodating the electrode assembly and having an open side and an electrode terminal; a case cover sealing the open side of the case; and an anisotropic conductive film on the electrode tab, the anisotropic conductive film electrically connecting and joining the electrode tab and the electrode terminal.

The anisotropic conductive film may include an adhesive portion formed of an insulating material and joining the electrode tab and the electrode terminal; and a conductive portion inside the adhesive portion and electrically connecting the electrode tab and the electrode terminal.

The electrode tab and the anisotropic conductive film may be bent, and the anisotropic conductive film may face the case cover.

The electrode tab may be at an end of one side surface of the electrode assembly close to the case cover, and the anisotropic conductive film may be on a surface of the electrode tab facing the case cover.

The electrode tab and the anisotropic conductive film may be bent two or more times, and the anisotropic conductive film may face the case cover.

The electrode tab may be at a center of one side surface of the electrode assembly, and the anisotropic conductive film may be on a surface of the electrode tab facing the case cover.

The electrode tab may be at an end of one side surface of the electrode assembly far away from the case cover, and the anisotropic conductive film may be on a surface of the electrode tab facing the case cover.

A length of the anisotropic conductive film may be equal to or longer than a length of the electrode tab.

A width of the anisotropic conductive film may be equal to or greater than a width of the electrode tab.

The secondary battery according to some embodiments may further include an insulating film attached to an opposite side surface of one side surface of the electrode tab to which the anisotropic conductive film may be attached.

The electrode tab may include a first electrode tab connected to a first electrode and a second electrode tab connected to a second electrode, the electrode terminal may include a first electrode terminal connected to a first electrode tab and a second electrode terminal connected to a second electrode tab, and the anisotropic conductive film may include a first anisotropic conductive film that electrically connects and joins the first electrode tab and a first electrode terminal, and a second anisotropic conductive film that electrically connects and joins the second electrode tab and a second electrode terminal.

Embodiments are directed to a method for manufacturing a secondary battery, the method including attaching an anisotropic conductive film to an electrode tab of an electrode assembly, bringing the anisotropic conductive film into contact with an electrode terminal provided in a case; pressing and heating the anisotropic conductive film so as to electrically connect and join the electrode terminal and the electrode tab, accommodating the electrode assembly in the case while bending the electrode tab and the anisotropic conductive film, and fastening a case cover to an open side of the case.

The anisotropic conductive film may include an adhesive portion having a thickness of about 10 μm to about 25 μm and formed of an insulating material; and a conductive portion having a diameter of about 5 μm to about 20 μm and formed of a metal material disposed inside the adhesive portion.

The pressing and heating of the anisotropic conductive film may include pressing at a pressure of about 0.8 MPa to about 3.0 MPa while heating at about 100° C. to about 200° C. for about 1 second to about 20 seconds.

The pressing and heating of the anisotropic conductive film may include primarily heating to 100° C. to 150° C. for 1 second to 10 seconds and pressing to a pressure of 0.8 MPa to 1.2 MPa; and secondarily heating to 150° C. to 200° C. for 10 seconds to 20 seconds and pressing at a pressure of 1.2 MPa to 3.0 MPa.

The electrode tab may be at an end of one side surface of the electrode assembly close to the case cover, and the accommodating of the electrode assembly in the case may include accommodating the electrode assembly in the case while bending the electrode tab and the anisotropic conductive film.

The accommodating the electrode assembly in the case may include bending the electrode tab and the anisotropic conductive film to rotate the electrode assembly toward the outside of the case, and accommodating the electrode assembly in the case while bending the electrode tab and the anisotropic conductive film in an opposite direction.

The electrode tab may be at a center of one side surface of the electrode assembly, and the anisotropic conductive film may be on a surface of the electrode tab facing the case cover.

The electrode tab may be at an end of one side surface of the electrode assembly far away from the case cover, and the anisotropic conductive film may be on a surface of the electrode tab facing the case cover.

The method according to some embodiments may further include attaching an insulating film to an opposite side surface of the electrode tab to which the anisotropic conductive film may be attached.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a plan view showing an example of a secondary battery according to some embodiments of the present disclosure.

FIG. 2 illustrates a cross-sectional view showing an example taken along line A-A of FIG. 1.

FIG. 3 illustrates a perspective view showing an example of an electrode assembly in a secondary battery according to some embodiments of the present disclosure.

FIG. 4 illustrates a side view showing an example in which the electrode assembly is joined to a case in the secondary battery according to some embodiments of the present disclosure.

FIG. 5 illustrates a cross-sectional view showing an example in which an electrode terminal and an electrode tab are joined by an anisotropic conductive film in the secondary battery according to some embodiments of the present disclosure.

FIG. 6 illustrates a side view showing an example in which the electrode assembly is joined to the case and stored therein in the secondary battery according to some embodiments of the present disclosure.

FIG. 7 illustrates a perspective view showing an example in which an insulating film is attached to the electrode tab in the secondary battery according to some embodiments of the present disclosure.

FIG. 8 illustrates a perspective view showing an example of an electrode assembly according to some embodiments of the present disclosure.

FIGS. 9 and 10 illustrate side views showing an example in which the electrode assembly according to some embodiments of the present disclosure is joined to a case and then accommodated therein.

FIG. 11 illustrates a perspective view showing an example in which an insulating film is attached to an electrode tab of the electrode assembly according to some embodiments of the present disclosure.

FIG. 12 illustrates a perspective view showing an example of an electrode assembly according to some embodiments of the present disclosure.

FIGS. 13 and 14 illustrate side views showing an example in which the electrode assembly according to some embodiments of the present disclosure is joined to a case and then accommodated therein.

FIG. 15 illustrates a perspective view showing an example in which an insulating film is attached to an electrode tab of the electrode assembly according to some embodiments of the present disclosure.

FIG. 16 illustrates a flowchart showing an example of a method of manufacturing a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

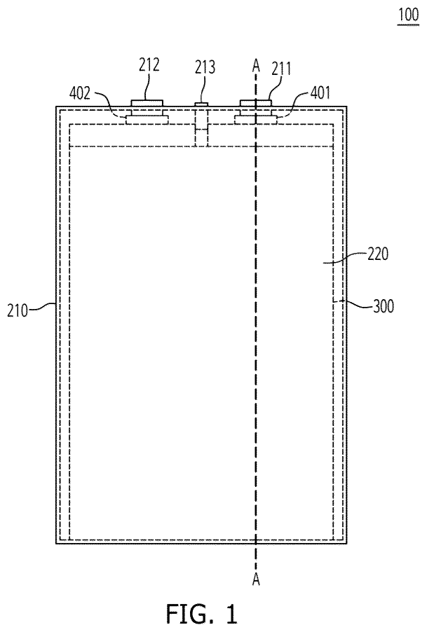

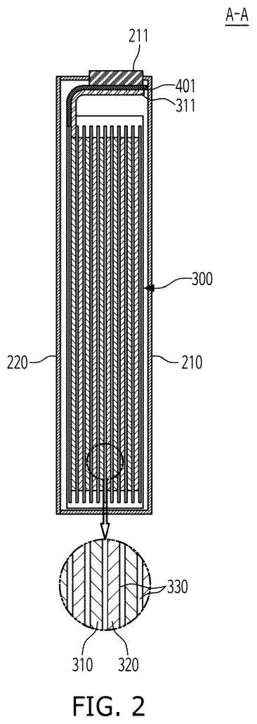

FIG. 1 illustrates a plan view showing an example of a secondary battery according to some embodiments of the present disclosure, and FIG. 2 illustrates a cross-sectional view showing an example taken along line A-A of FIG. 1.

Referring to FIGS. 1 and 2, a secondary battery 100 according to some embodiments of the present disclosure may include an electrode assembly 300 including electrode tabs 311 and 321 protruding to one side, a case 210 having one open side, accommodating the electrode assembly 300, and including electrode terminals 211 and 212, a case cover 220 sealing the open side of the case 210, and anisotropic conductive films 401 and 402 on the electrode tabs 311 and 321 and electrically connecting and joining the electrode tabs 311 and 321 and the electrode terminals 211 and 212.

The anisotropic conductive films 401 and 402 may include an adhesive including an insulating material and conductive particles inside the adhesive. In a case where the anisotropic conductive films 401 and 402 are pressed and heated between the electrode tabs 311 and 321 and the electrode terminals 211 and 212, the conductive particles may electrically connect the electrode tabs 311 and 321 and the electrode terminals 211 and 212, and the adhesive may join the electrode tabs 311 and 321 and the electrode terminals 211 and 212. As illustrated in FIGS. 1 and 2, the electrode assembly 300 may be accommodated in the case 210 and the electrode tabs 311 and 321 and the anisotropic conductive films 401 and 402 may be bent, and the anisotropic conductive films 401 and 402 may face, e.g., directly face, the case cover 220.

The case 210 may form the overall appearance of the secondary battery 100. For example, in an implementation, the case 210 joined to the case cover 220 may completely enclose all the other components of the secondary battery. The case 210 may be formed of steel use stainless (SUS). In some embodiments, the case 210 may be formed of a conductive metal such as aluminum, an aluminum alloy, or nickel-plated steel.

The case 210 may have one open side so that the electrode assembly 300 may be accommodated therein. The case cover 220 may be joined to the open side of the case 210 to seal the open side of the case 210. According to some embodiments, the case cover 220 may be on the open side of the case 210 and the case cover 220 and the case 210 may be welded and joined along the contacting circumference of the open side of the case 210. In some embodiments, other suitable methods and configurations for joining the case 210 and the case cover 220 may be used.

A first electrode terminal 211 and a second electrode terminal 212 may pass through one side of the case 210. The first electrode terminal 211 may be electrically connected to a first electrode tab 311 of a first electrode 310 of the electrode assembly 300. The second electrode terminal 212 may be electrically connected to a second electrode tab 321 of a second electrode 320 of the electrode assembly 300.

One of the first electrode terminal 211 and the second electrode terminal 212 may be electrically insulated from the case 210. In some embodiments, in a case where the case 210 functions as a negative electrode and the second electrode terminal 212 functions as a positive electrode, an insulating member may be further provided between the second electrode terminal 212 and the case 210. With this configuration, the second electrode terminal 212 may function as a positive electrode while being insulated from the case 210, and the first electrode terminal 211 may function as a negative electrode while being in contact with the case 210. In some embodiments, the first electrode terminal 211 may also be electrically insulated from the case 210.

An electrolyte injection port for injecting an electrolyte may be formed on one side of the case 210. After the electrode assembly 300 is accommodated in the case 210 and the case cover 220 is sealed on the case 210, the electrolyte may be injected into the case 210 through the electrolyte injection port. In order to prevent the injected electrolyte from leaking out, a sealing member 213 may be joined to the electrolyte injection port to seal the electrolyte injection port. The sealing member 213 may be, e.g., a sealing pin.

An electrode assembly 300 may be formed by winding or stacking a stack of a first electrode 310, a separator 330, and a second electrode 320, which are formed as thin plates or films. When the electrode assembly 300 is a wound stack, a winding axis may be parallel to the longitudinal direction of the case 210. In other embodiments, the electrode assembly 300 may be a stack type rather than a winding type, and the shape of the electrode assembly 300 is not limited in the present disclosure. In addition, the electrode assembly 300 may be a Z-stack electrode assembly 300 in which a positive electrode plate and a negative electrode plate are inserted into both sides of a separator 330, which is then bent into a Z-stack. In addition, one or more electrode assemblies may be stacked such that long sides of the electrode assemblies are adjacent to each other and accommodated in the case 210, and the number of electrode assemblies in the case 210 is not limited in the present disclosure. The first electrode 310 of the electrode assembly 300 may act as a negative electrode, and the second electrode 320 may act as a positive electrode. Of course, the reverse is also possible.

The first electrode 310 may be formed by applying a first electrode active material, such as graphite or carbon, to a first electrode current collector formed of a metal foil, such as copper, a copper alloy, nickel, or a nickel alloy. The first electrode 310 may include a first electrode tab 311 that is a region to which the first electrode active material is not applied. The first electrode tab 311 may act as a current flow path between the first electrode 310 and the first current collector. In some embodiments, when the first electrode 310 is manufactured, the first electrode tab 311 may be formed by being cut in advance to protrude to one side of the electrode assembly 300, or the first electrode tab 311 may protrude to one side of the electrode assembly 300 more than (e.g., farther than or beyond) the separator 330 without being separately cut.

The second electrode 320 may be formed by applying a second electrode active material, such as a transition metal oxide, on a second electrode current collector formed of a metal foil, such as aluminum or an aluminum alloy. The second electrode 320 may include a second electrode tab 321 that is a region to which the second electrode active material is not applied. The second electrode tab 321 may act as a current flow path between the second electrode 320 and the second current collector. In some embodiments, the second electrode tab 321 may be formed by being cut in advance to protrude to the other side (e.g., the opposite side) of the electrode assembly 300 when the second electrode 320 is manufactured, or the second electrode 320 may protrude to the other side of the electrode assembly 300 more than (e.g., farther than or beyond) the separator 330 without being separately cut.

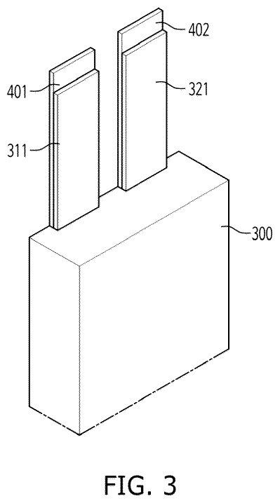

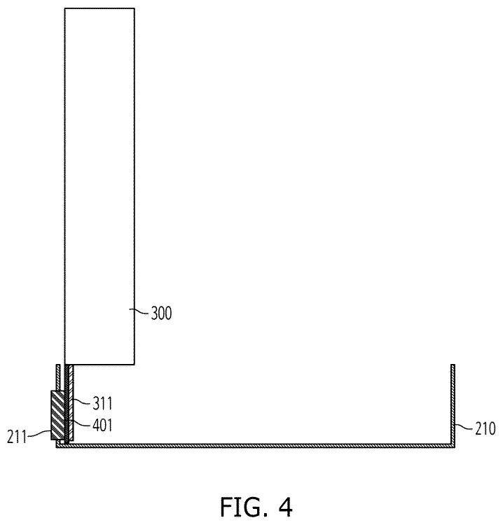

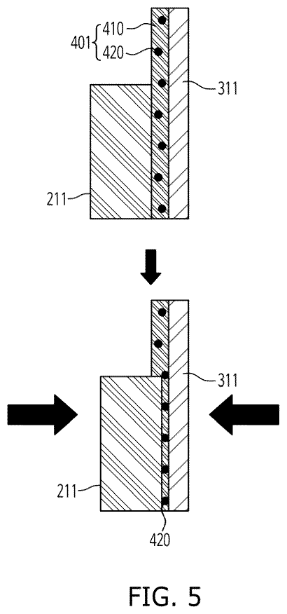

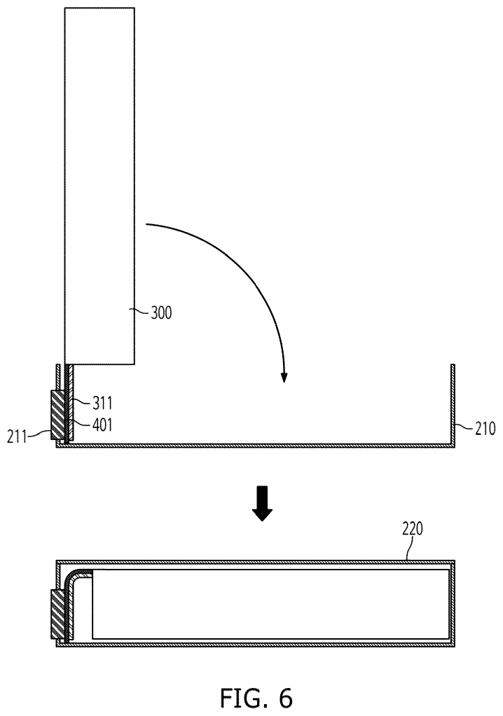

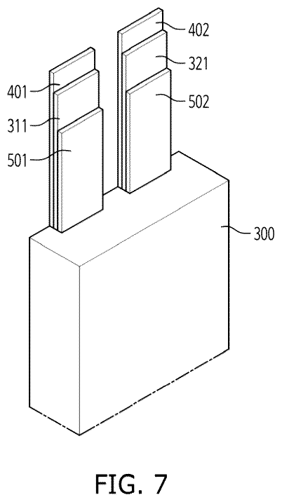

FIG. 3 illustrates a perspective view showing an example of an electrode assembly in a secondary battery according to some embodiments of the present disclosure, FIG. 4 illustrates a side view showing an example in which the electrode assembly is joined to a case in the secondary battery according to some embodiments of the present disclosure, and FIG. 5 illustrates a cross-sectional view showing an example in which an electrode terminal and an electrode tab are joined by an anisotropic conductive film in the secondary battery according to some embodiments of the present disclosure. FIG. 6 illustrates a side view showing an example in which the electrode assembly is joined to the case and stored therein in the secondary battery according to some embodiments of the present disclosure, and FIG. 7 illustrates a perspective view showing an example in which an insulating film is attached to the electrode tab in the secondary battery according to some embodiments of the present disclosure.

Referring to FIGS. 3 to 7, in an electrode assembly 300 according to some embodiments of the present disclosure, electrode tabs 311 and 321 may be electrically connected and joined to electrode terminals 211 and 212 by anisotropic conductive films 401 and 402 on the electrode tabs 311 and 321.

A first anisotropic conductive film 401 on the first electrode tab 311 may join the first electrode tab 311 and the first electrode terminal 211, and a second anisotropic conductive film 402 on the second electrode tab 321 may join the second electrode tab 321 and the second electrode terminal 212.

The first anisotropic conductive film 401 and the second anisotropic conductive film 402 may have the same configuration and function, and the following description is based on the first anisotropic conductive film 401. In some embodiments, the first electrode tab 311 and the second electrode tab 321 may protrude in parallel to one another in the same direction, and the first electrode terminal 211 and the second electrode terminal 212 may also be parallel to one another. Accordingly, the joining relationship and arrangement relationship between the second electrode tab 321, the second anisotropic conductive film 402, and the second electrode terminal 212 may be the same as those described below with respect to the first anisotropic conductive film 401.

The first anisotropic conductive film 401 may include an adhesive portion 410 formed of an insulating material and a conductive portion 420 inside the adhesive portion 410. In some embodiments, the adhesive portion 410 may have a thickness of about 10 μm to about 25 μm and may be formed of an insulating material, and the conductive portion 420 may have a diameter of about 5 μm to about 20 μm and may be a sphere or particle formed of a metal material.

With this configuration, referring to FIG. 5, in a case where the first anisotropic conductive film 401 is between the first electrode tab 311 and the first electrode terminal 211 and then the first electrode tab 311 and the first electrode terminal 211 are pressed and heated, the adhesive portion 410 may melt and the plurality of conductive portions 420 may be electrically connected by coming into contact with the first electrode tab 311 and the first electrode terminal 211. In a case where the heating is stopped and the temperature cools to below a certain level, the melted adhesive portion 410 may cool, thereby physically joining the first electrode tab 311 and the first electrode terminal 211.

The length of the first anisotropic conductive film 401 may be formed to be equal to or longer than the length of the first electrode tab 311. As illustrated in FIG. 4, the first anisotropic conductive film 401 may protrude further outward from the end of the first electrode tab 311 than the first electrode tab 311 and thereby prevent the first electrode tab 311 from contacting the bottom surface of the case 210.

The width of the first anisotropic conductive film 401 may be equal to or greater than the width of the first electrode tab 311. A portion other than the portion where the first electrode tab 311 is joined to the first electrode terminal 211 may face the case cover 220. The first anisotropic conductive film 401 may cover the first electrode tab 311 so as to prevent the first electrode tab 311 from contacting the case cover 220.

The first electrode tab 311 may be at an end of the electrode assembly 300 and in a direction close to the case cover 220. For example, the first electrode tab may be at an end of one side surface of the electrode assembly 300 close to the case cover. The first anisotropic conductive film 401 may be on the surface of the first electrode tab 311 facing the case cover 220.

With this configuration, the first electrode tab 311 may be joined to the first electrode terminal 211 using the first anisotropic conductive film 401. As illustrated in FIG. 6, the electrode assembly 300 may be rotated and accommodated in the case 210, and then, the case cover 220 may be joined to and assembled with the case 210.

In some embodiments, the electrode assembly 300 may be accommodated in the case 210 and the first electrode tab 311 and the first anisotropic conductive film 401 may be bent once. The first anisotropic conductive film 401 may face the case cover 220. That is, the first anisotropic conductive film 401 may be directly on the first electrode tab 311 and between the first electrode tab 311 and the case cover 220 so as to electrically insulate the first electrode tab 311.

Accordingly, it may be possible to avoid using additional or separate insulating sheets. In some embodiments, because the electrode assembly 300 is directly accommodated in the case 210 by bending once after the first electrode tab 311 is joined to the first electrode terminal 211, the length of the first electrode tab 311 may be minimized.

In some embodiments, referring to FIG. 7, the first anisotropic conductive film 401 and the second anisotropic conductive film 402 may be respectively attached to one side surface of the first electrode tab 311 and one side surface of the second electrode tab 321, and a first insulating film 501 and a second insulating film 502 may respectively be attached to the opposite side surface of the first electrode tab 311 and the opposite side surface of the second electrode tab 321. The one side surface of the first electrode tab 311 and the one side surface of the second electrode tab 321 may be respectively attached to the first anisotropic conductive film 401 and the second anisotropic conductive film 402 and thus be electrically insulated from each other. Additionally, the opposite side surfaces of the first electrode tab 311 and the second electrode tab 321 may be respectively attached to the first insulating film 501 and the second insulating film 502 and thus be electrically insulated from each other.

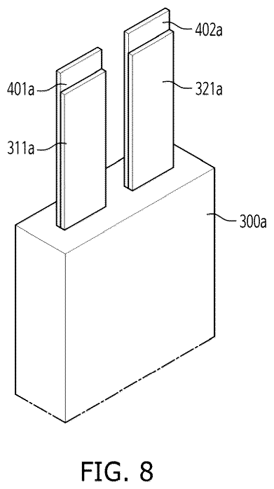

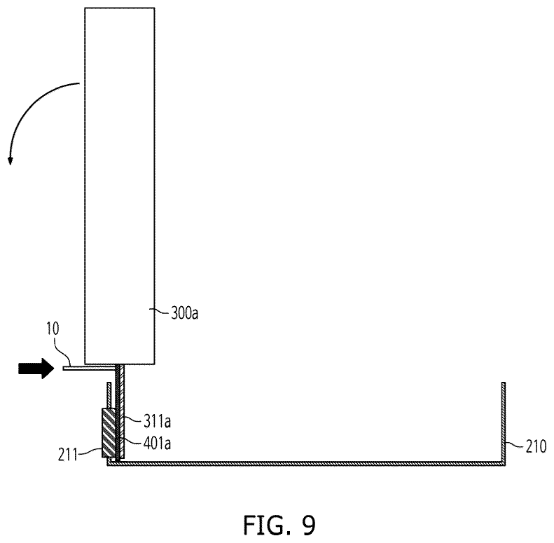

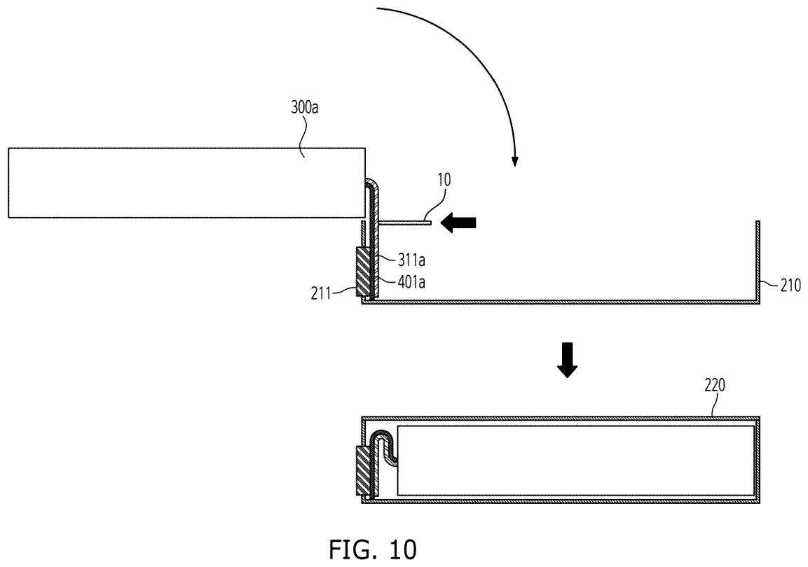

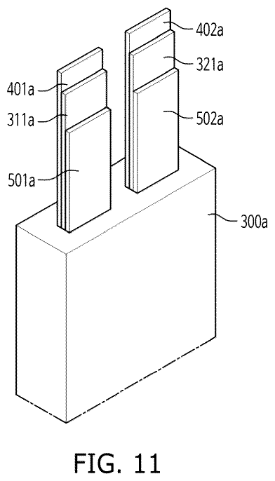

FIG. 8 illustrates a perspective view showing an example of an electrode assembly according to some embodiments of the present disclosure, and FIGS. 9 and 10 illustrate side views showing an example in which the electrode assembly according to some embodiments of the present disclosure is joined to a case and then accommodated therein. FIG. 11 illustrates a perspective view showing an example in which an insulating film is attached to an electrode tab of the electrode assembly according to some embodiments of the present disclosure.

Referring to FIGS. 8 to 11, in an electrode assembly 300a according to some embodiments of the present disclosure, electrode tabs 311a and 321a may be approximately at the center of one side surface of the electrode assembly 300a. Anisotropic conductive films 401a and 402a may be respectively on one side surface of the first electrode tab 311a and one side surface of the second electrode tab 321a.

With this configuration, referring to FIG. 9, after the first anisotropic conductive film 401a is disposed between the first electrode terminal 211 and the first electrode tab 311a, the first electrode terminal 211 and the first electrode tab 311a may be electrically connected and joined by applying pressure and heat to the first electrode terminal 211 and the first electrode tab 311a. For example, the first electrode tab 311a may be electrically connected and joined to the first electrode terminal 211 through the first anisotropic conductive film 401a.

In order to accommodate the electrode assembly 300a in the case 210, the portion connected to the electrode assembly 300a on the side of the first anisotropic conductive film 401a may be pressed by a bending guide 10 and the electrode assembly 300a may be rotated toward the outside of the case 210, e.g., away from the open side of the case 210. The first electrode tab 311a and the first anisotropic conductive film 401a may be bent counterclockwise with respect to the drawing. Referring to FIG. 10, the electrode assembly 300a may be accommodated in the case 210 by pressing a portion of the first electrode tab 311a that is lower than the height of the case 210 with the bending guide 10. As shown in FIG. 10, the first electrode tab 311a and the first anisotropic conductive film 401a may be bent clockwise with respect to the drawing as the electrode assembly is rotated towards the open side of the case 210 and the bending guide 10 presses the first electrode tab 311a.

The electrode assembly 300a may be accommodated in the case 210 while the first electrode tab 311a and the first anisotropic conductive film 401a are bent two or more times. For example, as shown in FIG. 10, the first electrode tab 311a and the first anisotropic conductive film 401a may have one bent portion that is adjacent the first electrode terminal 211 and another bent portion that is adjacent the electrode assembly 300a. The first anisotropic conductive film 401a may directly face the case cover 220, thereby preventing the first electrode tab 311a from contacting the case cover 220.

In some embodiments, referring to FIG. 11, a first anisotropic conductive film 401a and a second anisotropic conductive film 402a may be respectively attached to one side surface of the first electrode tab 311a and one side surface of the second electrode tab 321a, and a first insulating film 501a and a second insulating film 502a may be respectively attached to the opposite side surface of the first electrode tab 311a and the opposite side surface of the second electrode tab 321a. The one side surface of the first electrode tab 311a and the one side surface of the second electrode tab 321a may be respectively attached to the first anisotropic conductive film 401a and the second anisotropic conductive film 402a and thus be electrically insulated from each other. Additionally, the opposite side surfaces of the first electrode tab 311a and the second electrode tab 321a may be respectively attached to a first insulating film 501a and a second insulating film 502a and thus be electrically insulated from each other.

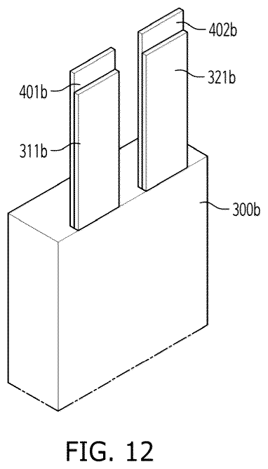

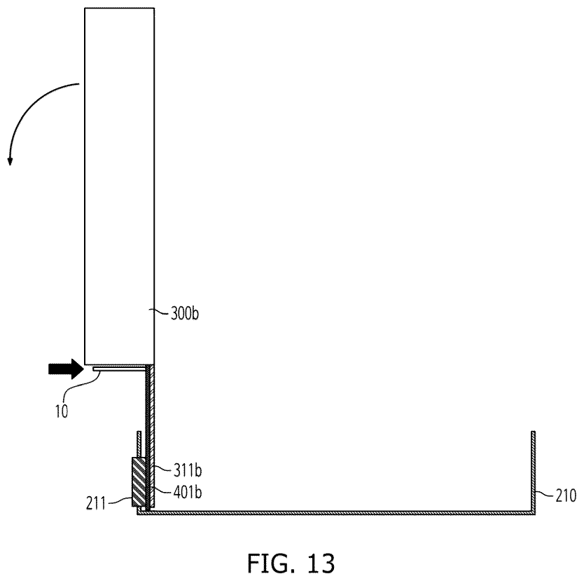

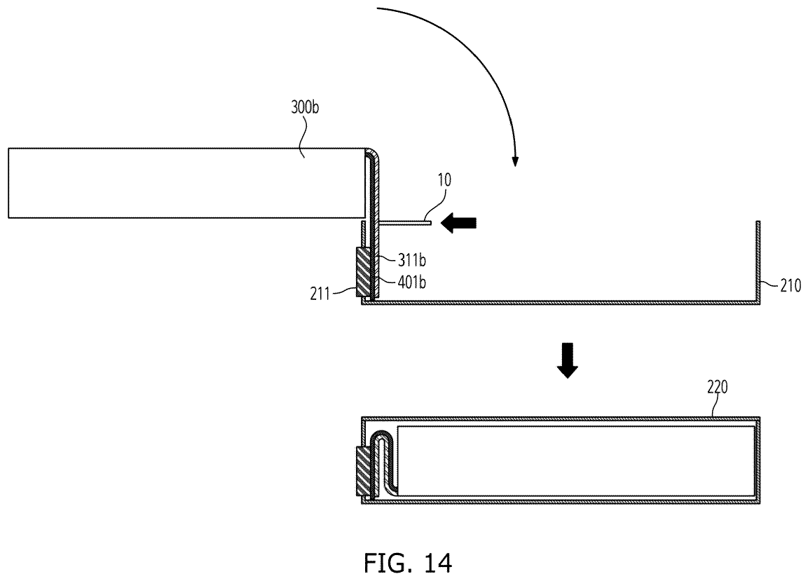

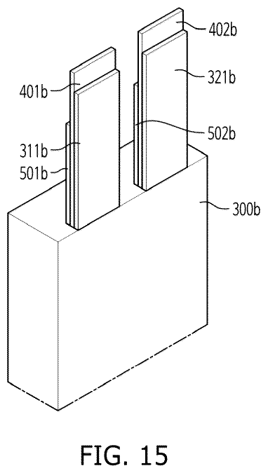

FIG. 12 illustrates a perspective view showing an example of an electrode assembly according to some embodiments of the present disclosure, and FIGS. 13 and 14 illustrate side views showing an example in which the electrode assembly according to some embodiments of the present disclosure is joined to a case and then accommodated therein. FIG. 15 illustrates a perspective view showing an example in which an insulating film is attached to an electrode tab of the electrode assembly according to some embodiments of the present disclosure.

Referring to FIGS. 12 to 15, in an electrode assembly 300b according to some embodiments of the present disclosure, electrode tabs 311b and 321b may be at an end of one side surface of an electrode assembly 300b far away from a case cover 220, e.g., close to the side of the case 210 opposite the case cover. Anisotropic conductive films 401b and 402b may be respectively on one side surface of the first electrode tab 311b and one side surface of the second electrode tab 321b. In some embodiments, the electrode tabs 311b and 321b may be formed on ends of opposite sides of the electrode tabs 311 and 321 formed in the electrode assembly 300 according to some embodiments of the present disclosure described with reference to FIG. 7.

With this configuration, referring to FIG. 13, after the first anisotropic conductive film 401b is disposed between the first electrode terminal 211 and the first electrode tab 311b, the first electrode terminal 211 and the first electrode tab 311b may be electrically connected and joined by applying pressure and heat to the first electrode terminal 211 and the first electrode tab 311b. For example, the first electrode tab 311b may be electrically connected and joined to the first electrode terminal 211 through the first anisotropic conductive film 401b.

In order to accommodate the electrode assembly 300b in the case 210, the portion connected to the electrode assembly 300b on the side of the first anisotropic conductive film 401b may be pressed by the bending guide 10 and the electrode assembly 300b may be rotated toward the outside of the case 210, e.g., away from the open side of the case 210. The first electrode tab 311b and the first anisotropic conductive film 401b may be bent counterclockwise with respect to the drawing. Referring to FIG. 14, the electrode assembly 300b may be accommodated in the case 210 by pressing a portion of the first electrode tab 311b that is lower than the height of the case 210 with the bending guide 10. As shown in FIG. 14, the first electrode tab 311b and the first anisotropic conductive film 401b may be bent clockwise with respect to the drawing as the electrode assembly is rotated towards the open side of the case 210 and the bending guide 10 presses the first electrode tab 311b.

The electrode assembly 300b may be accommodated in the case 210 while the first electrode tab 311b and the first anisotropic conductive film 401b are bent two or more times. For example, as shown in FIG. 14, the first electrode tab 311b and the first anisotropic conductive film 401b may have one bent portion that is adjacent the first electrode terminal 211 and another bent portion that is adjacent the electrode assembly 300b. The first anisotropic conductive film 401b may directly face the case cover 220, thereby preventing the first electrode tab 311b from contacting the case cover 220.

In some embodiments, referring to FIG. 15, a first anisotropic conductive film 401b and a second anisotropic conductive film 402b may be respectively attached to one side surface of the first electrode tab 311b and one side surface of the second electrode tab 321b, and a first insulating film 501b and a second insulating film 502b may be respectively attached to the opposite side surface of the first electrode tab 311b and the opposite side surface of the second electrode tab 321b. The one side surface of the first electrode tab 311b and the one side surface of the second electrode tab 321b may be respectively attached to the first anisotropic conductive film 401b and the second anisotropic conductive film 402b and thus electrically be insulated from each other. Additionally, the opposite side surfaces of the first electrode tab 311b and the second electrode tab 321b may be respectively attached to a first insulating film 501b and a second insulating film 502b and thus be electrically insulated from each other.

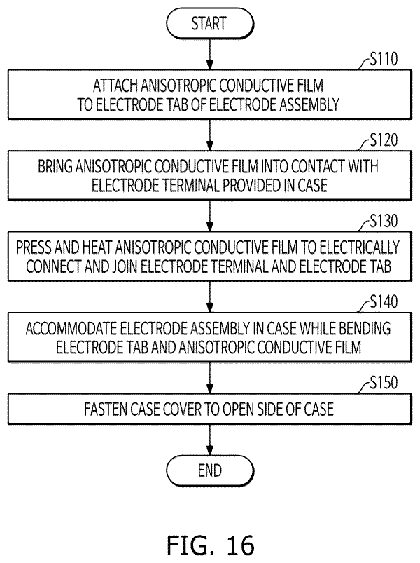

FIG. 16 illustrates a flowchart showing an example of a method of manufacturing a secondary battery according to some embodiments of the present disclosure.

Referring to FIG. 16, the method for manufacturing a secondary battery according to some embodiments of the present disclosure may include a step S110 of attaching an anisotropic conductive film to an electrode tab of an electrode assembly, a step S120 of bringing the anisotropic conductive film into contact with an electrode terminal provided in a case, a step S130 of pressing and heating the anisotropic conductive film to electrically connect and join the electrode terminal and the electrode tab, a step S140 of accommodating the electrode assembly in the case while bending the electrode tab and the anisotropic conductive film, and a step S150 of fastening a case cover to an open side of the case.

The anisotropic conductive film attached to the electrode tab may include an adhesive portion formed of an insulating material and a conductive portion inside the adhesive portion. In some embodiments, the adhesive portion may have a thickness of about 10 μm to about 25 μm and may be formed of an insulating material, and the conductive portion may have a diameter of about 5 μm to about 20 μm and may be a sphere or particle formed of a metal material.

In a case where the anisotropic conductive film is pressed and heated while being between the electrode terminal and the electrode tab, the adhesive portion may melt and a plurality of conductive portions may be electrically connected to the electrode tab and the electrode terminal in contact with the electrode tab and the electrode terminal. When the heating is stopped and the temperature is below a certain level, the melted adhesive portion may be cooled, thereby physically joining the electrode tab and the electrode terminal.

In some embodiments, the step S130 of pressing and heating the anisotropic conductive film may include a step of pressing at a pressure of about 0.8 MPa to about 3.0 MPa while heating at about 100° C. to about 200° C. for about 1 second to about 20 seconds. That is, the joining may be performed by heating and pressing to the target temperature and target pressure at once and then maintaining for a certain amount of time.

In some embodiments, the step S130 of pressing and heating the anisotropic conductive film may include a step of primarily pressing at a pressure of about 0.8 MPa to about 1.2 MPa while heating at about 100° C. to about 150° C. for about 1 second to about 10 seconds, and a step of secondarily pressing at a pressure of about 1.2 MPa to about 3.0 MPa while heating at about 150° C. to about 200° C. for about 10 seconds to about 20 seconds. That is, the pressing and heating step may be divided into two steps of preliminarily performing temporary bonding and secondarily performing final bonding. For example, the first pressing and heating step may include forming a preliminary bond and the second pressing and heating step may include forming a final bond.

As described above, after the anisotropic conductive film was joined to the metal plate under the pressing and heating conditions, the adhesive force (shear stress) test and the resistance characteristics test were performed to obtain excellent results.

The conditions for pressing and heating the anisotropic conductive film may be varied depending on the size of the anisotropic conductive film, the materials of the electrode terminal and electrode tab, and the like.

In some embodiments, the step S140 of accommodating the electrode assembly in the case may include a step of accommodating the electrode assembly in the case while bending the electrode tab and the anisotropic conductive film, as illustrated in FIG. 6.

The electrode assembly may be accommodated in the case as the electrode tab and the anisotropic conductive film are bent once. The anisotropic conductive film may face the case cover. That is, the anisotropic conductive film may be between the electrode tab and the case cover to electrically insulate the electrode tab.

In some embodiments, the step S140 of accommodating the electrode assembly in the case may include a step of bending the electrode tab and the anisotropic conductive film to rotate the electrode assembly toward the outside of the case, and a step of accommodating the electrode assembly in the case while bending the electrode tab and the anisotropic conductive film in the opposite direction.

In some embodiments, the electrode tab may be at the center of one side surface of the electrode assembly. In this instance, referring to FIG. 9, the portion connected to the electrode assembly on the anisotropic conductive film side may be pressed by the bending guide to rotate the electrode assembly toward the outside of the case. The electrode tab and the anisotropic conductive film may be bent counterclockwise with respect to the drawing. Referring to FIG. 10, the electrode assembly may be accommodated in the case by pressing the portion lower than the height of the case on the electrode tab side with the bending guide. The electrode tab and the anisotropic conductive film may be bent clockwise with respect to the drawing.

The electrode assembly may be accommodated in the case while the electrode tab and the anisotropic conductive film are bent two or more times. The anisotropic conductive film may be disposed to face the case cover, thereby preventing the electrode tab from coming into contact with the case cover.

In some embodiments, the electrode tab may be at the end of the electrode assembly far away from the case cover. In this case, referring to FIG. 13, the portion connected to the electrode assembly on the anisotropic conductive film side may be pressed by the bending guide to rotate the electrode assembly toward the outside of the case. The electrode tab and the anisotropic conductive film may be bent counterclockwise with respect to the drawing. Referring to FIG. 14, the electrode assembly may be accommodated in the case by pressing the portion lower than the height of the case on the electrode tab side with the bending guide. The electrode tab and the anisotropic conductive film may be bent clockwise with respect to the drawing.

The electrode assembly may be accommodated in the case while the electrode tab and the anisotropic conductive film are bent two or more times. The anisotropic conductive film may face the case cover, thereby preventing the electrode tab from coming into contact with the case cover.

The method for manufacturing the secondary battery according to some embodiments of the present disclosure may further include a step of attaching an insulating film to an opposite side of one side surface of the electrode tab to which the anisotropic conductive film is attached. The anisotropic conductive film may be attached to one side surface of the electrode tab, and the insulating film may be further attached to the opposite side of each side surface of the electrode tab. One side surface of the electrode tab may be electrically insulated by attaching the anisotropic conductive film, and the opposite side surface of the electrode tab may be electrically insulated by attaching the insulating film.

By way of summation and review, the electrode assembly may include electrode tabs joined to the electrode terminals provided in the case. Because the electrode assembly may be inserted into the case after joining the electrode tabs to the electrode terminals by welding or other means, the electrode tabs may be formed to be long. In a case where the electrode tabs are formed to be long, the electrode tabs may occupy space inside the case, which may be disadvantageous in terms of capacity.

According to some embodiments of the present disclosure, the electrode tab and the electrode terminal may be electrically connected and joined to each other by using an anisotropic conductive film, thereby minimizing the length of the electrode tab.

According to some embodiments of the present disclosure, the electrode tab and the electrode terminal may be electrically connected and joined to each other by using an anisotropic conductive film, thereby increasing the area occupied by the electrode assembly within the case of the secondary battery and increasing charging capacity.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including an electrode tab protruding to one side;
a case accommodating the electrode assembly and having an open side and an electrode terminal;
a case cover sealing the open side of the case; and
an anisotropic conductive film on the electrode tab, the anisotropic conductive film electrically connecting and joining the electrode tab and the electrode terminal.

2. The secondary battery as claimed in claim 1, wherein the anisotropic conductive film includes:
an adhesive portion formed of an insulating material and joining the electrode tab and the electrode terminal, and
a conductive portion inside the adhesive portion and electrically connecting the electrode tab and the electrode terminal.

3. The secondary battery as claimed in claim 1, wherein:
the electrode tab and the anisotropic conductive film are bent, and
the anisotropic conductive film faces the case cover.

4. The secondary battery as claimed in claim 1, wherein:
the electrode tab is at an end of one side surface of the electrode assembly close to the case cover, and
the anisotropic conductive film is on a surface of the electrode tab facing the case cover.

5. The secondary battery as claimed in claim 1, wherein:
the electrode tab and the anisotropic conductive film are bent two or more times, and
the anisotropic conductive film faces the case cover.

6. The secondary battery as claimed in claim 1, wherein:
the electrode tab is at a center of one side surface of the electrode assembly, and
the anisotropic conductive film is on a surface of the electrode tab facing the case cover.

7. The secondary battery as claimed in claim 1, wherein:
the electrode tab is at an end of one side surface of the electrode assembly far away from the case cover, and
the anisotropic conductive film is on a surface of the electrode tab facing the case cover.

8. The secondary battery as claimed in claim 1, wherein a length of the anisotropic conductive film is equal to or longer than a length of the electrode tab.

9. The secondary battery as claimed in claim 1, wherein a width of the anisotropic conductive film is equal to or greater than a width of the electrode tab.

10. The secondary battery as claimed in claim 1, further including an insulating film attached to an opposite side surface of one side surface of the electrode tab to which the anisotropic conductive film is attached.

11. The secondary battery as claimed in claim 1, wherein the electrode tab includes:
a first electrode tab connected to a first electrode and a second electrode tab connected to a second electrode,
the electrode terminal includes a first electrode terminal connected to a first electrode tab and a second electrode terminal connected to a second electrode tab, and
the anisotropic conductive film includes a first anisotropic conductive film that electrically connects and joins the first electrode tab and a first electrode terminal, and a second anisotropic conductive film that electrically connects and joins the second electrode tab and a second electrode terminal.

12. A method for manufacturing a secondary battery, the method comprising:
attaching an anisotropic conductive film to an electrode tab of an electrode assembly;
bringing the anisotropic conductive film into contact with an electrode terminal provided in a case;
pressing and heating the anisotropic conductive film so as to electrically connect and join the electrode terminal and the electrode tab;
accommodating the electrode assembly in the case while bending the electrode tab and the anisotropic conductive film; and
fastening a case cover to an open side of the case.

13. The method as claimed in claim 12, wherein the anisotropic conductive film includes:
an adhesive portion having a thickness of about 10μm to about 25μm and formed of an insulating material, and
a conductive portion having a diameter of about 5μm to about 20μm and formed of a metal material disposed inside the adhesive portion.

14. The method as claimed in claim 12, wherein the pressing and heating of the anisotropic conductive film includes pressing at a pressure of about 0.8 MPa to about 3.0 MPa while heating at about 100° C. to about 200° C. for about 1 second to about 20 seconds.

15. The method as claimed in claim 12, wherein the pressing and heating of the anisotropic conductive film includes:
primarily heating to 100° C. to 150° C. for 1 second to 10 seconds and pressing to a pressure of 0.8 MPa to 1.2 MPa; and
secondarily heating to 150° C. to 200° C. for 10 seconds to 20 seconds and pressing at a pressure of 1.2 MPa to 3.0 MPa.

16. The method as claimed in claim 12, wherein:
the electrode tab is at an end of one side surface of the electrode assembly close to the case cover, and
the accommodating of the electrode assembly in the case includes accommodating the electrode assembly in the case while bending the electrode tab and the anisotropic conductive film.

17. The method as claimed in claim 12, wherein the accommodating the electrode assembly in the case includes:
bending the electrode tab and the anisotropic conductive film to rotate the electrode assembly toward the outside of the case; and
accommodating the electrode assembly in the case while bending the electrode tab and the anisotropic conductive film in an opposite direction.

18. The method as claimed in claim 17, wherein:
the electrode tab is at a center of one side surface of the electrode assembly, and
the anisotropic conductive film is on a surface of the electrode tab facing the case cover.

19. The method as claimed in claim 17, wherein:
the electrode tab is at an end of one side surface of the electrode assembly far away from the case cover, and
the anisotropic conductive film is on a surface of the electrode tab facing the case cover.

20. The method as claimed in claim 12, further comprising attaching an insulating film to an opposite side surface of the electrode tab to which the anisotropic conductive film is attached.
